(19) United States
(12) Patent Application Publication
(10) Pub. No.: US 2003/0123833 A1
(43) Pub. Date: Jul. 3, 2003

(54) Embedded waveguide with alignment grooves and method for making same

(76) Inventors: Neal Ricks, Blacksburg, VA (US); Dan A. Steinberg, Blacksburg, VA (US); Mindaugas F. Dautartas, Blacksburg, VA (US); David W. Sherrer, Blackburg, VA (US)

Correspondence Address: HALEOS, INC., 3150 STATE STREET, BLACKSBURG, VA, 24060, US

(21) Appl. No.: 09/978,804

(22) Filed: Oct. 15, 2001

Related U.S. Application Data
(60) Provisional application No. 60/240,805, filed on Oct. 16, 2000.

(51) Int. Cl. G02B 6/00

(52) U.S. Cl. 385/137; 216/24

(57) ABSTRACT

The invention includes an integrated optical device having an embedded waveguide and an alignment groove. The waveguide is made by depositing waveguide material in a trench and then planarizing the chip. The alignment grooves can provide passive alignment for connecting the chip to other waveguides or optical fibers.

### RELATED APPLICATIONS

The present application claims the benefit of priority of copending provisional patent application No. 60/240,805 filed on Oct. 16, 2000, which is hereby incorporated by reference.

### FIELD OF THE INVENTION

The present invention relates generally to waveguide devices and mechanisms for aligning waveguides with other devices.

### BACKGROUND OF THE INVENTION

Integrated optical waveguides can be used for a number of signal processing tasks including switching, filtering, multiplexing, demultiplexing and the like. Integrated optical waveguides typically must be precisely aligned to optical fibers or other optical devices in order to be useful. Providing the precise alignment has often been difficult.

Typically, alignment between fiber and waveguide has been provided by actively monitoring the alignment of the devices. This can be done by monitoring the coupling efficiency, for example. A problem with this technique is that it is slow and requires expensive alignment equipment.

Alignment between fiber and waveguide has also been provided by forming mechanical features in the waveguide chip. Fibers or fiber holders are then fit into these features. This provides passive mechanical alignment between the fiber and the waveguide. Many such schemes are known in the art.

### SUMMARY

The present invention includes an integrated optical chip having a waveguide embedded in a substrate, and an alignment groove. The alignment groove is precisely located with respect to the waveguide. In one embodiment of the invention, the alignment groove and the waveguide are patterned in the same single mask step. The waveguide is formed in a trench by depositing waveguide core material, and, optionally, cladding material. The chip is planarized so that the waveguide core is isolated to the trench.

### DESCRIPTION OF THE FIGURES

FIG. 1 shows a perspective view of a waveguide chip according to the present invention.

FIG. 2 shows a chip according to the present invention coupled to a fiber array. The connection is provided in a manner similar to a mechanical transfer (‘MT’) connector.

FIG. 3 shows an alternative embodiment of the invention where the waveguide is covered with a top cladding layer.

FIGS. 4a-4e Illustrate a method for making the waveguide chips according to the present invention.

FIGS. 5a-5e Illustrate a second method for making the waveguide chips according to the present invention.

FIGS. 6a-6e Illustrate a method for making the trench and alignment groove according to the present invention.

FIG. 7 shows a chip where the alignment groove is in-line with the waveguide.

FIG. 8 shows a chip where an optical fiber is disposed in the in-line alignment groove of FIG. 7.

### DETAILED DESCRIPTION

The present invention provides a waveguide aligned with a groove. The waveguide is formed below the surface of a substrate in a Damascene-type process. The groove can be used to aligned optical fibers or other optical devices to the waveguide. For example, the groove can be used to hold and passively align optical fibers, or fiber arrays to the waveguide. The groove can be formed in the same lithographic process as the waveguide, so that alignment of the groove and waveguide is highly accurate.

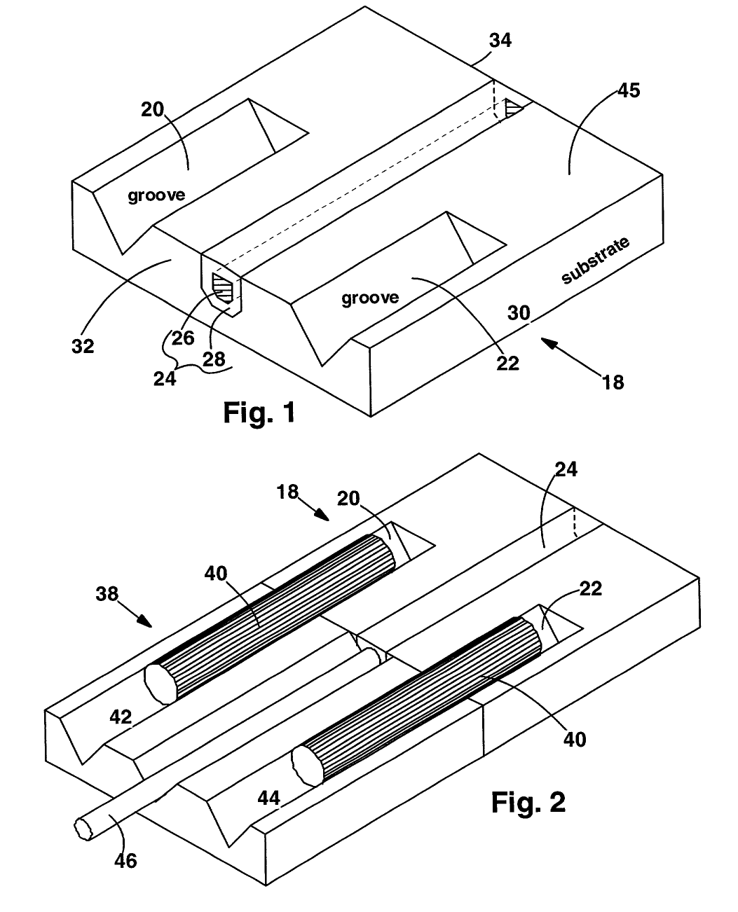

FIG. 1 shows an integrated optical device 18 according to the present invention. The integrated optical device has two alignment grooves 20, 22 disposed adjacent to a waveguide 24. The waveguide 24 includes a core 26 and a cladding 28. The alignment grooves 20, 22 and the waveguide 24 are formed in a substrate 30 which may comprise silicon or other material such as metal, ceramic, semiconductor, or polymer. The integrated optical device has a front face 32 and a back face 34. The front face 32 can be aligned and coupled to other optical devices such as optical fibers, waveguides, lenses or the like (not shown). The back face 34 may extend beyond what is illustrated to include waveguide devices. For example, the integrated optical device may extend to include arrayed waveguide gratings, couplers, filters switches or other optical devices (not shown).

It is important to note that the cladding material can be absent if the substrate is made of a material that can function as a cladding. For example, if the substrate is made of glass with a refractive index less than the waveguide core, then the cladding layer is optional. In this case, waveguide core 26 is in direct contact with the substrate.

If the substrate is made of (100) silicon, the alignment grooves can be V-grooves or U-grooves made by anisotropic wet etching of silicon, for example by potassium hydroxide.

The front face 32 of the present integrated optical device can be polished.

FIG. 2 shows the integrated optical device 18 coupled to a fiber array 38 according to an exemplary embodiment of the present invention. The fiber array 38 and the integrated optical device 18 are coupled by pins 40. Pins 40 are disposed in the alignment grooves 20, 22 and in alignment grooves 42, 44 in the fiber array 38. An optical fiber 46 is disposed in the fiber array 38. The mechanical connections between the integrated optical device 18, pins 40, and fiber array 38 assure that the optical fiber and the waveguide 24 are passively aligned. The coupling between the integrated optical device 18 and the fiber array 38 is similar to the connection in a mechanical transfer (‘MT’) style optical fiber connector.

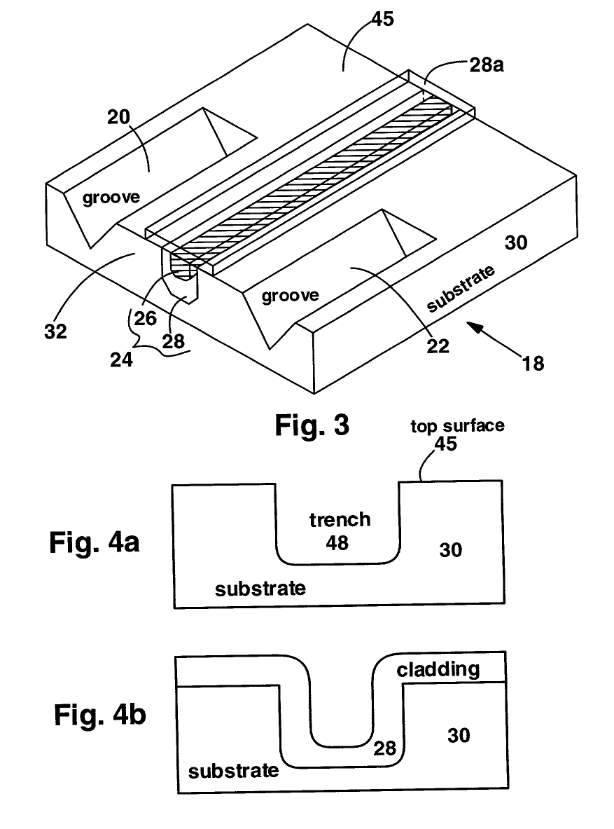

FIG. 3 shows an alternative embodiment where the waveguide is covered with a top cladding layer 28a. In this embodiment, the waveguide core 26 is illustratively shown to be flush with a top surface 45 of the substrate 30.

In the present invention, the embedded waveguide 24 is made by a Damascene-type process where a trench is filled with the waveguide cladding (optional) and the waveguide core (essential), and then the substrate is planarized. The planarization process generally removes the waveguide core material from all areas of the substrate outside the trench. When complete, the waveguide is in the trench below the top surface of the substrate.

Embedded waveguides have some advantages over waveguides deposited over a substrate. Embedded waveguide tend to have lower scattering losses because the core-cladding boundary is extremely smooth. Also, substrates with embedded waveguides tend to have lower stress because the waveguide material (typically oxide) is not deposited over the entire surface of the substrate.

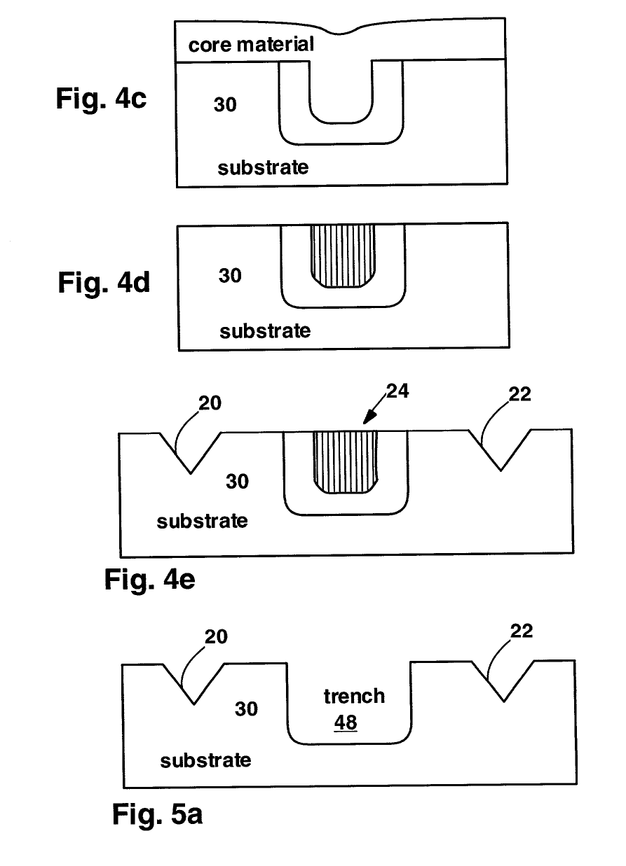

FIGS. 4a-4e Illustrate a method for making the waveguide integrated optical device of the present invention. FIGS. 4a-4e Are front views of the present integrated optical device. A process according to the present invention is described below:

FIG. 4a: A trench 48 is etched using reactive ion etching (RIE), wet etching, or a combination of RIE and wet etching. If desired, the sidewalls of the trench can be polished by a polishing etch or, in the case of a silicon substrate, a thermal oxidation followed by an oxide etch.

FIG. 4b: If a cladding is desired, a cladding layer 28 is deposited. The cladding layer 28 can be formed by CVD oxide, or thermal oxide if the substrate is made of silicon. Polymer materials can also be used for the cladding layer 28.

FIG. 4c: Optionally, (as shown) the cladding layer is removed by planarization (e.g. chemical-mechanical polishing). Waveguide core material is then deposited into the trench. The waveguide core material may fill the trench above the level of the substrate top surface. Alternatively, the waveguide core material does not fill above the substrate top surface.

FIG. 4d: The substrate is planarized. Optionally, after this step, the waveguide core material can be selectively etched, so that the core is below the level of the substrate top surface.

FIG. 4e: V-grooves 20, 22 are formed in the substrate. The V-grooves can be located precisely with respect to the waveguide 24 using lithographic techniques (e.g. using an edge of the waveguide as a fiduciary for aligning the V-grooves). The V-grooves can be formed by anisotropic wet etching if the substrate is made of single crystal silicon. The V-grooves can instead be grooves having other shapes such as a U-shape or rectangular shape.

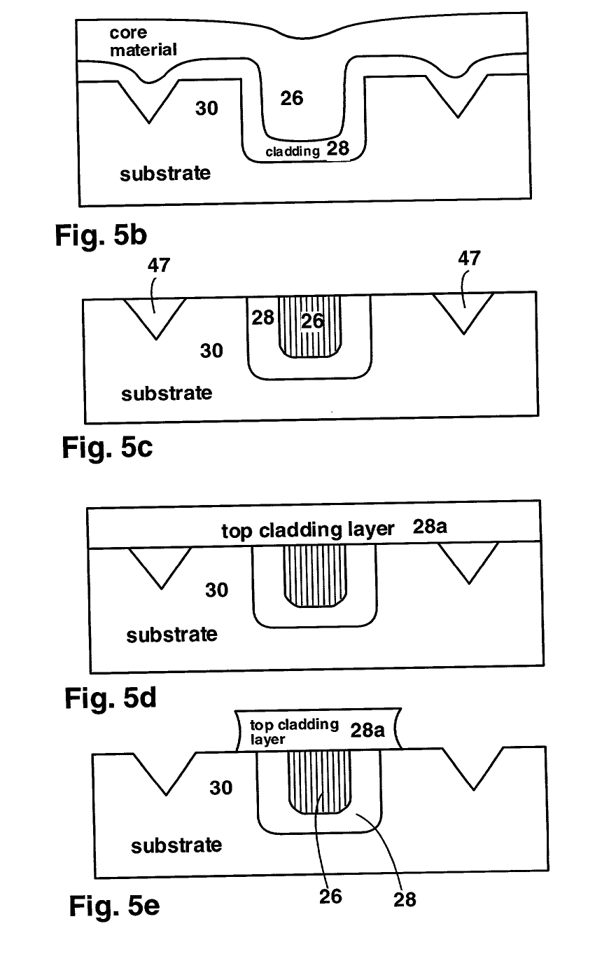

FIGS. 5a-5e describe an alternative method for making the integrated optical device according to the present invention. Figs. 5a-5e are front views.

FIG. 5a: The trench 48 and V-grooves 20, 22 are formed in the substrate. The trench 48 and the V-grooves 20, 22 can be made by the same or different etch processes. The V-grooves 20, 22 and trench 48 are preferably patterned in the same mask step, so that they are accurately aligned with respect to one another.

FIG. 5b: Cladding material 28 and core material are deposited on the substrate 30, covering the trench 48, and V-grooves 20, 22.

FIG. 5c: The integrated optical device is planarized, for example to the level of the substrate 30. The V-grooves 20, 22 may be filled with remnant material 47 (cladding material and, optionally, core material), as shown.

FIG. 5d: Optionally, a top cladding layer 28a is deposited on the substrate 30. The top cladding layer 28a can be SiO2 deposited by chemical vapor deposition or spin-on-glass, for example. It can also be a polymer layer.

FIG. 5e: The top cladding layer 28a is masked and etched so that the remnant material is removed from the V-grooves 20, 22. The top cladding layer 28a is preserved over the waveguide 24. The top cladding layer 28a can be spin-on-glass, CVD oxide, polymer or other materials. The top cladding layer 28a can be selected to etch slower than the remnant material 47.

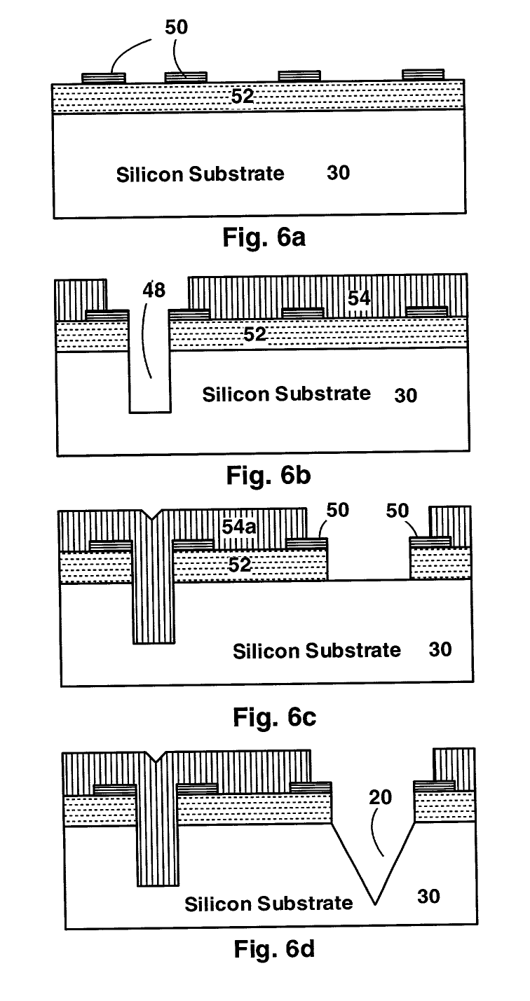

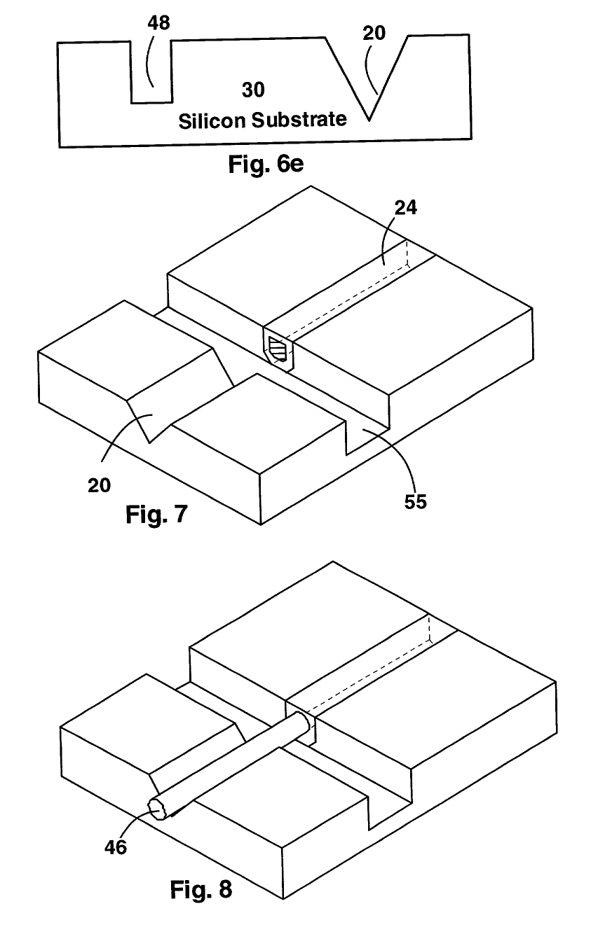

FIGS. 6a-6e illustrate how to form the trench 48 and V-grooves 20, 22 according to a single mask step. The method is related to a method described in copending U.S. patent application Ser. No. 09/519,165, incorporated herein by reference.

FIG. 6a: A substrate 30 is patterned with a metal layer 50 on a dielectric layer 52 (e.g. SiO2 or silicon nitride). The substrate 30 is (100) single crystal silicon. All the patterns in the metal layer 50 can be made in the same mask step, so that all the metal layer patterns are accurately located with respect to one another.

FIG. 6b: The substrate 30 is masked with a mask layer 54, and the trench 48 is formed by RIE or RIE combined with wet etching, for example. The trench location and shape are defined by the patterns in the metal layer 50.

FIG. 6c: The substrate 30 is remasked with a second mask layer 54a so that the trench 48 is protected. Then, the dielectric layer 52 is removed in an area defined by the metal layer 50, exposing the substrate. The dielectric layer 52 can be removed by wet or dry etching, for example. The area of the dielectric layer removed is defined by the pattern in the metal layer 50.

FIG. 6d: The substrate 30 is etched. In the specific embodiment shown, the etch is an anisotropic wet etch, forming a V-groove 20. The V-groove can be one of the V-grooves 20, 22 in the integrated optical device of FIG. 1.

FIG. 6e: The second mask 54a is removed, and, optionally, the dielectric layer 52 is removed. The trench 48 and V-groove 20 are precisely aligned because they were defined by the same ask step. The substrate 30 is ready to have waveguide material formed in the trench 48 as described above.

FIG. 7 shows another embodiment of the present invention where the alignment groove 20 is in-line with the embedded waveguide 24. A dicing saw cut 55 can be provided so that an optical fiber (not shown) disposed in the alignment groove 20 can be butted against the waveguide 24.

FIG. 8 shows the integrated optical device of FIG. 7 with an optical fiber 46.

Also, the pins 40 can be bonded to the grooves 20, 22. The pins 40 can be bonded to the grooves 20, 22 using solder, epoxy or other materials.

The material of the waveguide can be CVD or thermal SiO2 or other low loss materials such as polymers.

It will be clear to one skilled in the art that the above embodiment may be altered in many ways without departing from the scope of the invention. Accordingly, the scope of the invention should be determined by the following claims and their legal equivalents.

What is claimed is:

1. A method for forming an integrated optical device, comprising the steps of:
a) forming at least one trench in the substrate;
b) forming at least one alignment groove located with respect to the trench;
c) depositing waveguide core material in the at least one trench;
d) planarizing the substrate so that a waveguide is defined.

2. The method of claim 1 further comprising the step of depositing a cladding material in the trench before step (c).

3. The method of claim 2 further comprising the step of removing the cladding material from the alignment groove.

4. The method of claim 1 wherein the waveguide core material is deposited over the substrate in areas outside the trench.

5. The method of claim 1 further comprising the step of forming a top cladding layer after step (d).

6. The method of claim 1 wherein the alignment groove is formed by anisotropic etching, and the substrate is made of (100) silicon.

7. The method of claim 1 wherein steps (a) and (b) include patterning the trench and alignment groove in a single mask step.

8. The method of claim 1 wherein step (b) is performed after step (d).

9. The method of claim 1 wherein steps (a) and (b) are performed before step (c).

10. An integrated optical device, comprising:
a) a substrate having at least one trench;
b) a waveguide core disposed in the at least one trench;
c) at least one alignment groove in the substrate that is located with respect to the waveguide core.

11. The integrated optical device of claim 10 comprising at least one alignment groove on each side of the waveguide.

12. The integrated optical device of claim 11 further comprising pins disposed in the at least one alignment groove.

13. The integrated optical device of claim 10 further comprising a cladding layer disposed between the waveguide core and the trench.

14. The integrated optical device of claim 10 wherein the waveguide core has a top surface, and the substrate has a top surface, wherein the waveguide top surface is flush with the substrate top surface.

15. The integrated optical device of claim 10 further comprising a top cladding layer disposed on the waveguide core.

16. The integrated optical device of claim 10 wherein the substrate is made of (100) silicon and the alignment grooves are anisotropically etched V-grooves.

17. The integrated optical device of claim 10 wherein the substrate has a front face, and wherein the at least one waveguide core, trench, and at least one alignment groove intersect the front face.

18. The integrated optical device of claim 17 wherein the waveguide core and at least one alignment groove are parallel at the front face.

19. The integrated optical device of claim 10 wherein the at least one alignment groove is in-line with the waveguide core.

20. An integrated optical device, comprising:
a) a substrate having at least one trench;
b) a waveguide core disposed in the at least one trench;
c) at least one alignment groove in the substrate that is in-line with the waveguide core, so that an optical fiber disposed in the alignment groove is aligned with the waveguide core.
